(19) United States
(12) Patent Application Publication
(10) Pub. No.: US 2002/0077094 A1
(43) Pub. Date: Jun. 20, 2002

(54) UPGRADING SOFTWARE IN A MOBILE TELEPHONE

(76) Inventor: REIJO LEPPANEN, ESPOO (FI)

Correspondence Address: DAVID W. LYNCH, ALTERA LAW GROUP, LLC, 6500 CITY WEST PARKWAY, SUITE 100, MINNEAPOLIS, MN, 55344-7701, US

(21) Appl. No.: 09/051,944

(22) PCT Filed: Oct. 29, 1996
(86) PCT No.: PCT/FI96/00574

(30) Foreign Application Priority Data
Oct. 30, 1995 (FI) 955188

(51) Int. Cl. H04M 3/00

(52) U.S. Cl. 455/420; 455/418; 455/419

(57) ABSTRACT

A prior art method for upgrading a mobile station is to change at least partly software contained therein in a service shop, for example. This solution is not satisfactory to a user of mobile station. In accordance with the invention, the mobile station (MS) is designed to that its software can be be changed at least partly. A software databse (SDB) connected to a mobile communication network (NSS) contains the most recent versions of the softwares of the mobile stations. A downloading unit (DLU) checks the softwares of the mobile stations by means of the database (SDB) and when necessary, loads the software into the mobile station.

The present invention relates to upgrading of software, especially of speech coding software in mobile telephones. In some cases different operators of mobile communication networks may use a different speech coding algorithm. Alternatively, the software of a mobile station can be suitable in principle but a more recent version of it may have been developed.

Mobile communication systems develop rapidly. When facilities are added or improved, a problem will be how to add these facilities to existing mobile stations. Prior art for improving a mobile station is to change at least partly the software therein in a service shop. This solution is not satisfactory to a user of a mobile station. The maintenance of software in a service shop may not be a good solution for the service shop either as this work rather causes peaks in work load than permanent business.

The object of the invention is to upgrade software in a mobile station so that the mobile station need not be taken for this purpose to a service shop. The objects of the invention are achieved with the methods and systems that are characterized by what is stated in the independent claims. Preferred embodiments are disclosed in the dependent claims.

The invention is based on the idea that software in a mobile station is arranged to be at least partly variable in response to incoming signals from outside the mobile station. In some embodiments of the invention, actual executable code is transferred to a mobile station. In the second embodiments, the program best corresponding to the prevailing conditions is selected from the software preinstalled in the mobile station. In the third embodiments, the preinstalled and externally loaded software modules cooperate in such a manner that at least parts of each are executed.

An advantage of the method and system of the invention is for a user of a mobile station primarily that when new facilities are added, the mobile station need not be changed or even taken to a service shop.

This also gives a competitive advantage to the mobile station manufacturer. Another advantage for the manufacturer is that the testing of the product may be shortened and the introduction of the product to the market can be expedited if the product can be upgraded even after delivery. The advantage to a network operator is that facilities can be added more flexibly as the user has subscriber terminal equipments which are technically ready for the use of new facilities.

The invention will now be explained in more detail by means of preferred embodiments with reference to the accompanying drawings, wherein

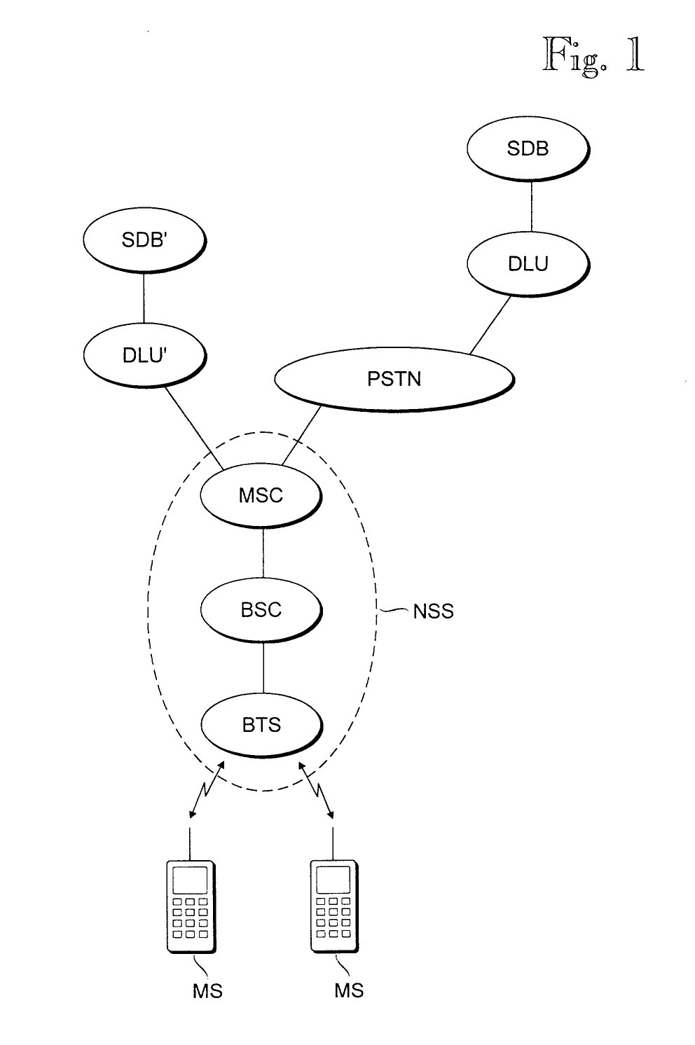

FIG. 1 shows the elements of the mobile communication system essential for the invention;

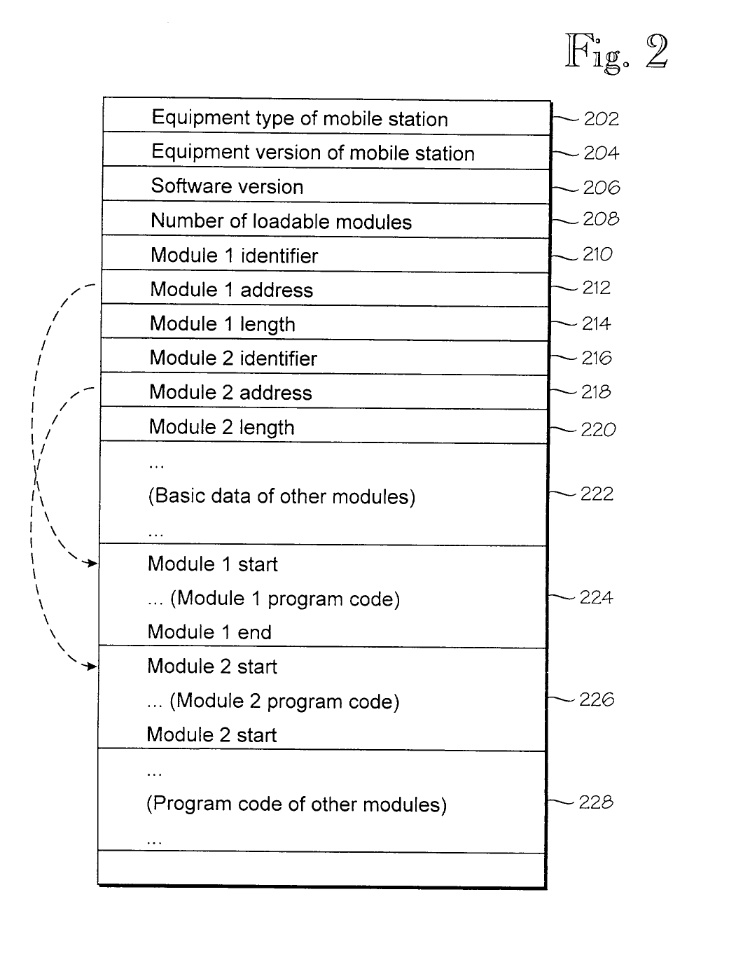

FIG. 2 shows an exemplary form of one record of a software database;

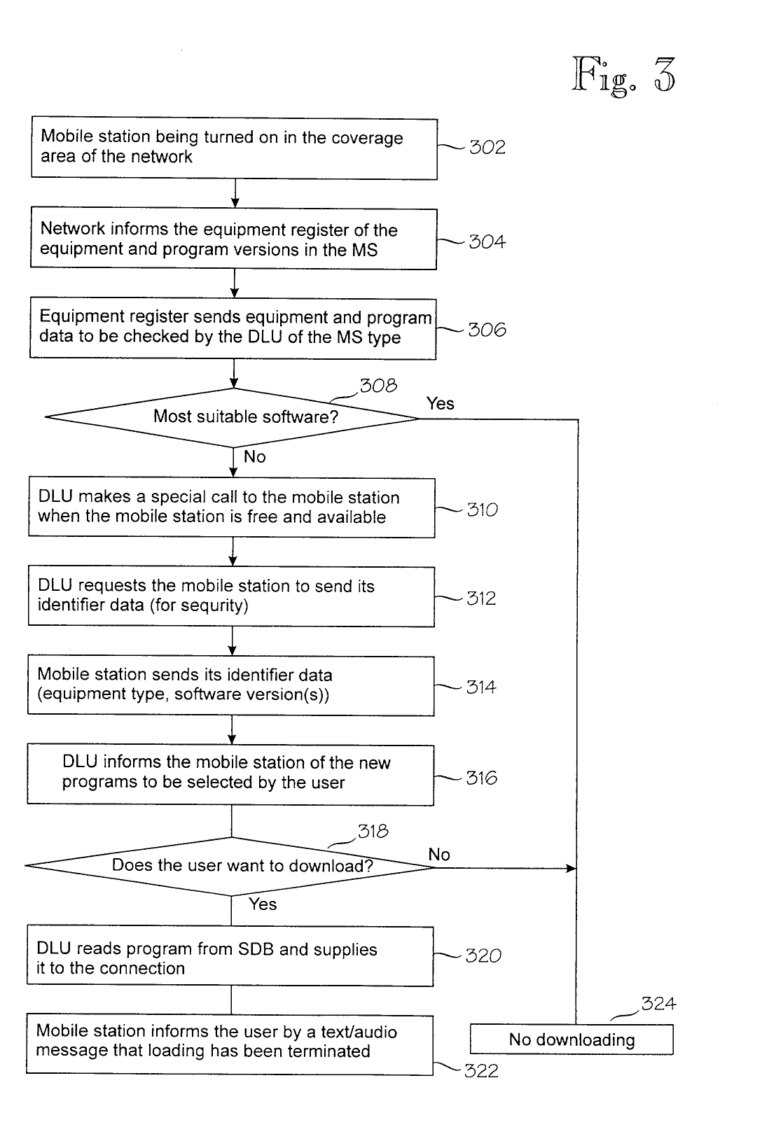

FIG. 3 shows process steps when the mobile communication system starts loading a program;

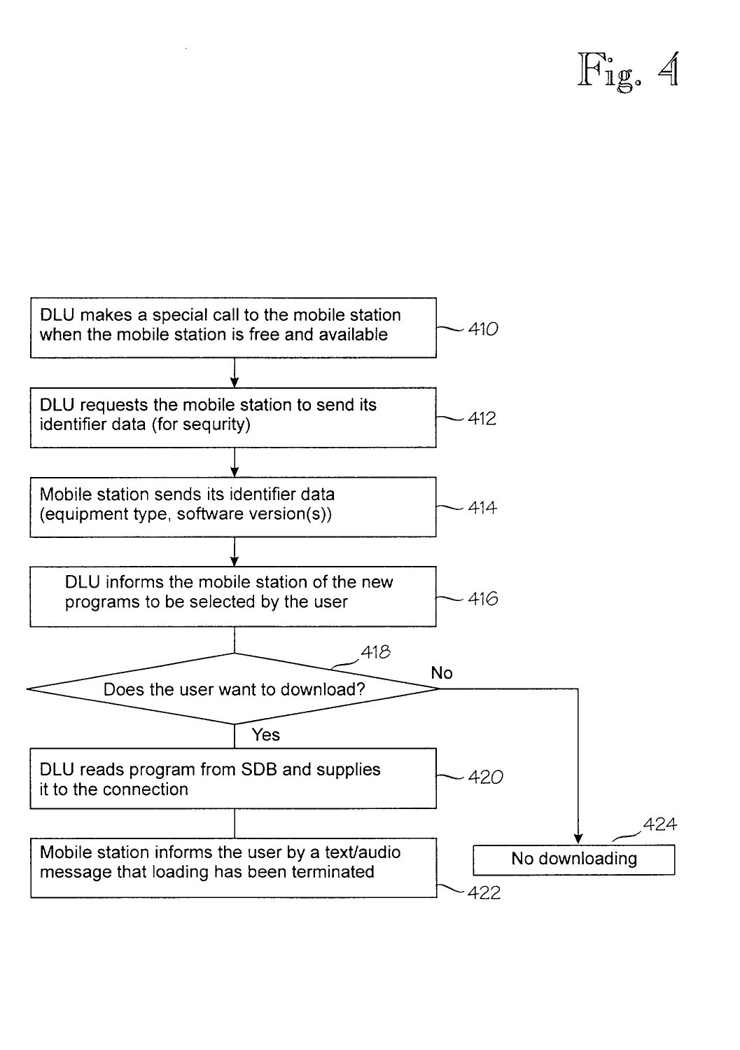

FIG. 4 shows process steps when a mobile station starts loading a program;

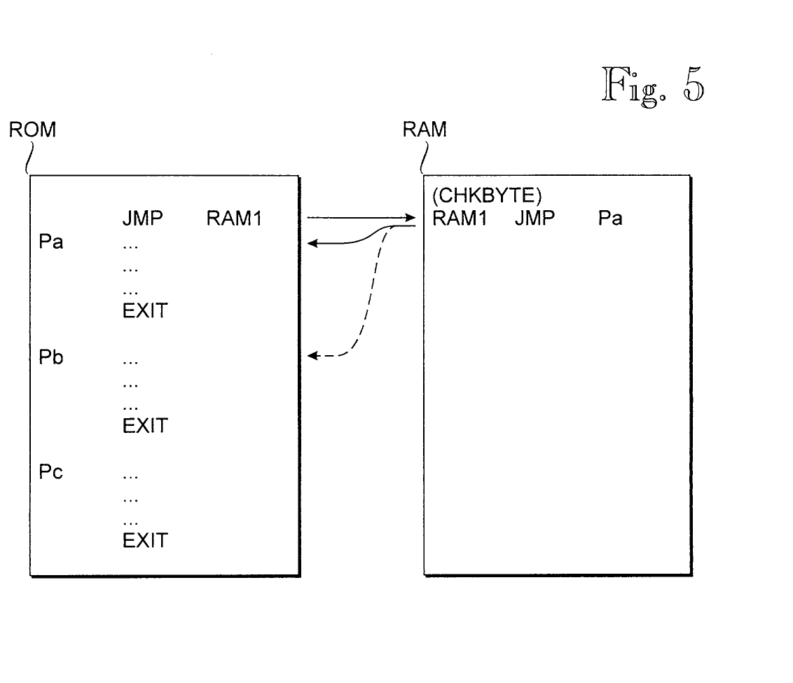

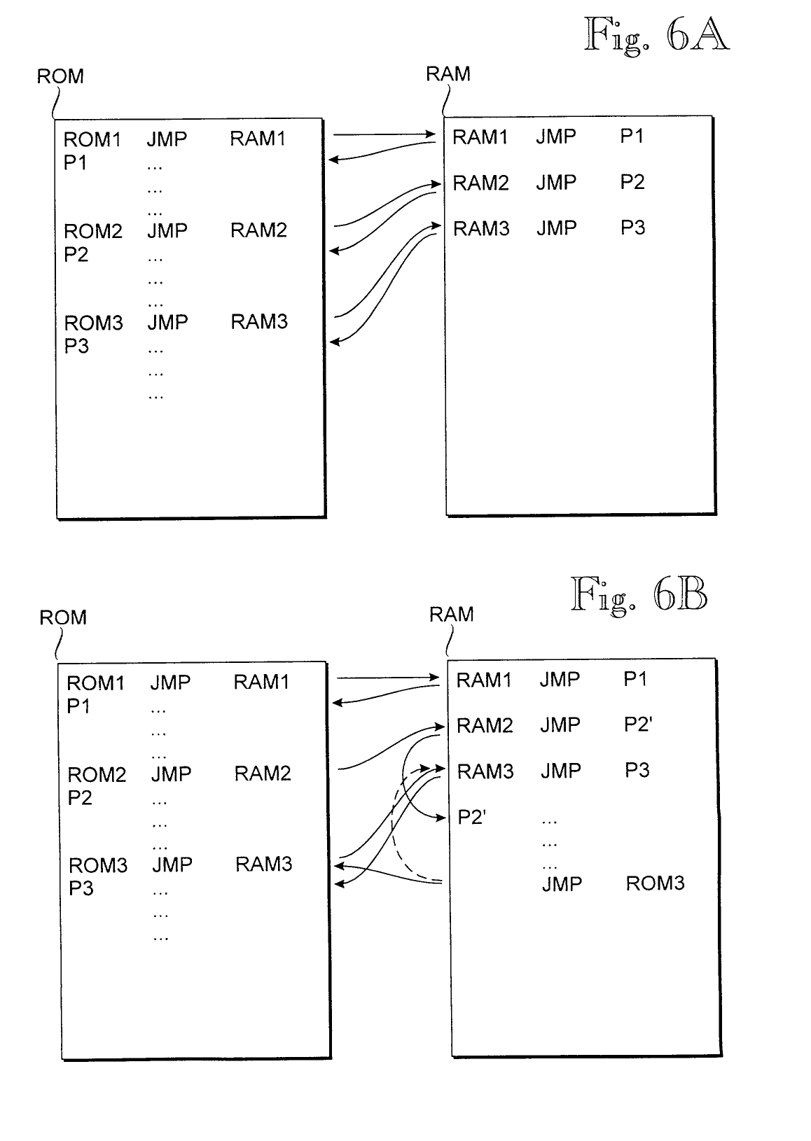

FIGS. 5 to 6 shows different techniques for changing the software of a mobile station.

FIG. 1 shows the elements of the mobile communication system essential for the invention. Mobile stations MS are connected to a base station BTS in a manner known per se. The base station BTS is connected to a base station controller BSC, which is, in turn, connected to a mobile services switching centre MSC. The network elements BTS to MSC form Network SubSystems (NSS) connected to other subsystems and the public switched telephone network PSTN. The elements of the subsystem NSS may naturally have a tree structure in such a manner that several base stations BTS may be connected to one controller BSC and similarly, several base station controllers BSC to one exchange MSC.

In accordance with one embodiment of the invention, Downloading Units DLU attend to the loading of software into mobile stations. Information on the software contained in the mobile stations is maintained in Software Database SDB. There may be only one or several software databases SDB. If the system includes only one software database SDB, all mobile services switching centres MSC can be connected to this software database via the public switched telephone centre PSTN, for example. In this case, the software database SDB corresponds to a great extent to the home location register HLR of the mobile communication system. The loading of software into the mobile station can be started for example so that when the mobile station is registering into the network, the network sends an inquiry to the mobile station about the software it contains. If the mobile station does not respond to the inquiry in any way, the network deduces that the mobile station does not support this feature and the procedures will end. On the other hand, if the mobile station responds to the network as expected and indicates it contains the most suitable software, there is no need for loading the software, and the procedure ends in this case, too. A need for loading the software arises only when the mobile telephone responds to the inquiry to the network relating to the software and the response contains an indication that the software of the mobile station is not in all parts the most suitable one for this network. When a new software is loaded into the software database SDB, it can update the software of the mobile station to correspond to the loaded software.

The network (and especially the software downloading unit DLU) then has to deduce how urgently the software should be loaded. If the mobile station is moving to an area of an operator where the used speech coding or other necessary program is not compatible, the loading of software should be started immediately. On the other hand, if the network finds out that the mobile station supports full-rate speech coding, but not for example enhanced full-rate speech coding, the network may inform the mobile station that this software supporting enhanced full-rate speech coding can be loaded. The user can then load the software at the required time by calling a specified service number, for example. The enhanced full rate speech coding in the GSM system used herein is only one example of this feature. It is not essential for the invention how the speech coding program operates, but how this program can be transferred into a mobile station. The same method could be used for transferring a more advanced identification procedure, a power saving algorithm or the like.

When software is loaded into a mobile station, the loading may take place on a traffic channel, for example, in such a manner that the whole capacity of one traffic channel is allocated to the loading of software into one mobile station at a time. The network may then send first a header field containing information on the program to be loaded (program type, function, version, length, etc.). The header field is followed by the contents of the program divided for example into several frames which may contain a checksum. When the mobile telephone receives a frame, it calculates the checksum from the data contained in the frame and compares it to the sent checksum. If the checksums are equal, the frame is stored into memory. If the checksums are different from one another, the mobile station may request the erroneous frame or the whole software to be loaded again. When the whole software is loaded (possibly after repeating some frames), it can be activated for use. “Activation” does not necessarily mean that the program would be executed immediately but when said program is needed the next time.

As an alternative to loading the software at each connection, the network may send new programs on some broadcast control channel to all mobile stations. This embodiment could be implemented by sending continuously new programs, for example.

FIG. 2 shows an exemplary form of a record of the software database SDB. Field 202 shows the equipment type of the mobile station and field 204 the equipment version. Similarly, the program version is in field 206. Field 208 shows the number of modules capable of being loaded into the mobile station. Fields 210 to 214 include identification data of the modules in triplets: the identifier of the module, the initial header and the length of the module. The next three fields contain corresponding information for the next module. Field 208 indicates the number of these triplets. The program code of module 1 is in area 224, of module 2 in area of 226, etc.

Although the easiest way to check the software of a mobile station is to compare the version numbers, it is not the only way. The compatibility of the software may be checked in other ways, for example by means of a checksum or by testing how the mobile station will respond to a specified message sent thereto.

FIG. 3 shows process steps when the mobile communication system starts loading the software.

FIG. 3 shows an embodiment where the operation is initiated by the mobile station being turned on in the coverage area of the network (step 302). In step 304 the network informs the equipment register of the equipment and program versions in the mobile station. In step 306 the equipment register sends the equipment and program data to be checked by the DLU of the mobile station type in question. In step 308 the DLU checks if the mobile station already has the most suitable software for the mobile station type. In step 310 the DLU makes a special call to the mobile station when the mobile station is free and available. In step 312 the DLU requests the mobile station to send its identifier data. In step 314 the mobile station sends its identifier data, e.g. the equipment type and the software versions. In step 316 the DLU informs the mobile station of the new programs to be selected by the user. In step 318 it is inquired on the display of the mobile station (or alternatively, by an audio signal) if the user requires loading. In step 320 the DLU reads the program from the SDB and supplies it to the connection. In step 322 the mobile station informs the user by a text or audio message that loading has been terminated.

FIG. 4 shows process steps when the mobile station starts loading the software. In step 410 the user makes a special call to the service number (the DLU) of the network. Steps 412 to 424 correspond to steps 312 to 324 explained in connection with FIG. 3 and they will not be explained again.

In the following, the changes required by the loading of software according to the invention are examined. In an ordinary mobile station software is generally installed in one read-only-memory (ROM) whose contents cannot be changed after the manufacturing stage. In this connection, “ROM” refers to a fixedly programmed memory whose contents cannot be changed at least with the equipment in the mobile station. “RAM” similarly refers to a memory whose contents can be changed with the equipment in the mobile station. “Program to be updated” refers to the part of the software in a mobile station to be changed. Furthermore, “version” in this context is to be understood to refer widely to all modifications and not just to modifications of a different age.

The software of a mobile station of the invention may be updated e.g. in the following ways: (i) the mobile station may contain in the ROM several alternative programs one of which is selected for execution; (ii) the same as (i) but the programs are located in the RAM, and (iii) the ROM and RAM of the mobile station can cooperate so that parts of both are executed.

FIG. 5 shows how a mobile station may contain several programs in the ROM one of which is selected for processing. In program segments the left column signifies a label at the source code level and a corresponding address in the executable code. Pseudocode JMP in the second column refers to a jump to the label mentioned in the third column or to a corresponding address in the executable code. The ellipsis (. . . ) represents the part of the program to be executed. The pseudocodes “EXIT” terminating programs Pa to Pc naturally restore control to an upper level program.

The ROM contains in this example three alternative programs Pa to Pc of which at least one can be activated so that the execution of the program is preceded by a jump in the RAM to the address RAM1 to which is initialized a jump to the program (e.g. Pa) which is executed by default if not programmed otherwise. This default situation is described by unbroken arrows between the ROM and RAM. Any one of the programs Pa to Pc can be activated by writing a jump to the program in question in place of the jump instruction in the address RAM1 of the RAM. This change is illustrated by an arrow indicated with broken lines between the ROM and RAM. Before the program is executed, the processor of the mobile station can also make sure that the jump instruction in the address RAM1 contains a jump to a meaningful address. If this is not the case, the mobile station may initialize the jump instruction in the address RAM1 again to be directed to a program executed by default. The fact that the jump instruction is directed to a meaningful address can be ensured for example by calculating the checksum at least from part of the program to be executed. In order that the checksum need not be calculated from all the software, one check byte (CHKBYTE in this example) may be placed in front of the 3 byte jump instruction in the address RAM1 and the checksum can be calculated from the produced 4 byte area.

A restriction to the above described embodiment is that only such programs can be stored into the ROM whose contents are known at the manufacturing stage. In this way telephones can be manufactured to operate in the operation area of two or more network operators even when the operators require different programs.

If the contents of the program are not known at the stage when the mobile station is manufactured, the contents of the program can be changed in such a manner that the mobile station contains the RAM to which one or more programs or at least parts of them are stored. The ROM and RAM preferably cooperate in such a manner that only the parts to be changed in the program have to be stored in the RAM. FIGS. 6A and 6B show an example of how the cooperation of the ROM and RAM can be realized. FIG. 6a shows an initial situation. Some program in the ROM comprises three parts P1 to P3. As distinct from the situation in FIG. 5, the parts P1 to P3 are not here alternatives but different parts of one program, all of which have to be executed. Execution of each part P1 to P3 is preceded by a jump to an address in the RAM, to the RAM1 to RAM3, respectively, to which a jump back to the parts P1 to P3 of the program in the RAM is initialized. One of these parts P1 to P3 can be replaced by a corresponding part in the RAM so that a jump to the replaced part of the program is written in the place of the jump instruction in the RAM. Replacing part P2 by a second part P2′ is discussed as an example. A problem is caused by that the contents of the replacing part P2′ and even its size are not known at the manufacturing stage of the mobile station. In the initial situation of FIG. 6a the jump instruction of address RAM2 can be replaced only by an instruction of the same length (the length of the jump instruction is typically 3 bytes), without new data being written into the address RAM3. The address RAM3 cannot be transferred as in the address ROM3 of the ROM there is a jump to this address and the contents of the ROM cannot be changed. Referring to FIG. 6B, the problem is solved in such a manner that the part P2′ replacing the part P2 is placed in the empty part in the RAM and a jump instruction is placed in the address RAM2 at the beginning of the replacing part P2′. As after executing the original part P2, the program proceeds to the address ROM3, a jump to the end of the part P2′ should also be placed in the same address. As there is any case a jump to the address RAM3 in this address, one jump instruction can be saved by terminating the part P2′ by a jump instruction to the address RAM3, as shown by the arrow indicated with broken lines in FIG. 6B.

The cooperation of the RAM and ROM saves resources of the mobile station, such as storage capacity and program downloading time.

In the following it is examined how a program can be transferred into a mobile station. Several embodiments are given for this: (i) the program may be loaded via the radio path; (ii) one of several preinstalled programs can be selected via the radio path; (iii) the program may be loaded by a smart card or a magnetic card; and (iv) the mobile station may cooperate with a general-purpose computer.

The loading of a program to a mobile station has already been discussed in connection with the changes the technique requires of a mobile communication network. The selection of one of several preinstalled programs can be realized in the way explained in connection with FIG. 5, whereby information on the program to be executed is sent via the mobile communication network.

A program can be loaded to a mobile station by a smart card or a magnetic card. In this case there are two alternatives in use: the program can be executed directly from a smart card or it can be copied therefrom to the RAM of the mobile station. In the last mentioned case it can apply the technique explained in connection with FIG. 6, by means of which the program of the mobile station can be only partly replaced.

The mobile station may also cooperate with a general-purpose computer. This embodiment is based on the observation that most users of mobile stations also use a general-purpose computer, either at work or at home. A mobile station may cooperate in many ways with a computer. According to one embodiment, the program need not be loaded via the radio path but the program is loaded first into the memory of the computer by means of a modem connection of the general-purpose computer. Alternatively, the program may be sent in a diskette readable by the computer. Cooperation with the computer has the advantage that the programs of the users of the mobile station using a computer can be updated by means of diskettes sent by post.

When the program is loaded into the memory of the general-purpose computer, it may be transferred therefrom to the memory of the mobile station via a data connection if one is available in the mobile station. Alternatively, the mobile station may have a PCMCIA or other such smart card connection.

The data connection of a mobile station may be a wired connection in series or an infrared connection that is becoming more general in laptop computers and their accessories.

The mobile station and the computer may both contain a PCMCIA card slot whereby a card of PCMCIA type may first be programmed in the computer and transferred into a mobile station.

Especially when the program is transferred in another way than via cable from the computer, it is preferable to send the program in a compressed form for minimizing transmission time. Although compression requires resources (storage space and calculation -capability), decompression consumes resources only little. As a rule, the packing programs generally used in computers condense typical programs into a 1.5 to 2 times smaller space. If the decompressing program is not to be stored into the ROM, it can be sent along with the program to be transferred.

It is evident for those skilled in the art that as the art develops, the basic idea of the invention can be realized in many ways. The invention and its embodiments are thus not restricted to the examples described above, but they can vary within the scope of the claims.

1. A method for updating software in a mobile station, characterized in that the method comprises the steps of:
establishing a connection between the mobile station and a mobile communication network (NSS);
checking the software in the mobile station (MS); and
in response to that the software in the mobile station (MS) does not correspond to the software required by the mobile communication network (NSS), updating the software in the mobile station (MS).

2. A method according to claim 1, characterized in that updating the software in the mobile station (MS) comprises selecting the most suitable one of the programs preinstalled in the mobile station (MS).

3. A method according to claim 1, characterized in that updating the software in the mobile station (MS) comprises loading at least a substantial part of an executable program, preferably of a speech coding program into the mobile station (MS).

4. A method according claim 3, characterized in that said at least a substantial part of an executable program is loaded via a radio path.

5. A method according to any one of claims 1 to 4, characterized in that the software in the mobile station (MS) is checked when the mobile station (MS) is registering into the network (NSS).

6. A method according to any one of claims 1 to 4, characterized in that the software in the mobile station (MS) is checked in connection with an incoming call to the mobile station or an outgoing call from the mobile station.

7. A method according to claim 4, characterized by the steps of:
dividing the software to be updated into at least one block and calculating a checksum of each block;
sending each one of said blocks with its corresponding checksum from the network (NSS), one block at a time, and receiving same with the mobile station (MS);
calculating, with the mobile station (MS), a checksum from each received block and comparing the calculated checksum to the received checksum;
in response to the calculated checksum equalling the received checksum, storing the block into the mobile station; and in response to the calculated checksum not equalling the received checksum, requesting with the mobile station (MS) the network (NSS) to resend the block; and
in response to the software to be updated being entirely and successfully received, activating said software.

8. A method according to claim 4, characterized in that loading the software into the mobile station (MS) comprises the steps of:
broadcasting the software to be updated from the network (NSS) in blocks, each block having an associated checksum and a storage address;
receiving with the mobile station (MS) each block of the software to be updated and calculating a checksum from it;
in response to the calculated checksum equalling the received checksum, storing the block into the corresponding storage address in the mobile station (MS); and in response to the calculated checksum not equalling the received checksum, repeating the receiving and storing steps in respect of the block in question when it is sent the next time;
repeating the preceding three steps until the software to be updated has been entirely received.

9. A method according to claim 1, characterized by the steps of:
installing in the network at least one software database (SDB) being adapted to store information on the programs contained in the mobile stations;
installing in the network at least one downloading unit (DLU) being adapted to: compare at least one program in the mobile station (MS) with the most suitable corresponding program intended for said mobile station type, and in response to the program of the mobile station (MS) not being the most suitable version, to update the program of the mobile station (MS), or at least to inform the mobile station (MS) that a more suitable program can be loaded.

10. A method according to claim 9, characterized in that the downloading unit (DLU) updates the program in the mobile station (MS) upon detecting that the mobile station (MS) is not having an active call.

11. A method according to claim 10, characterized in that:
at least one telephone number is reserved for loading the programs; and
the user of the mobile station (MS) initiates the loading of the program by calling the number reserved for program loading.

12. A method for updating software in a mobile station (MS), characterized by the steps of:
loading a program to be updated into a general-purpose computer;
establishing a connection between the mobile station (MS) and the general-purpose computer;
checking at least one program of the mobile station (MS); and
in response to the checked program not being the most suitable one, loading the program to be updated from the general-purpose computer into the mobile station (MS).

13. A method according to claim 12, characterized in that the program is sent with a data connection like a serial connection of a computer and received with a data connection of the mobile station (MS).

14. A method according to claim 12, characterized by sending the program with an infrared transmitter of the computer and receiving the program with an infrared receiver of the mobile station (MS).

15. A mobile station (MS) comprising a read-only-memory (ROM) and at least one program therein, characterized in that the mobile station (MS) further comprises:
a loading program in the read-only-memory (ROM) for loading the program to be updated;
means or receiving the program to be updated;
a read/write memory (RAM) for storing the program.

16. A mobile station (MS) according to claim 16, characterized in that the read-only-memory (ROM) and read-write memory (RAM) may cooperate in such a manner that the program to be updated comprises a basic part in the read-only-memory (RON) and a supplementary part In the read-write memory (RAM).

17. A mobile station (MS) according to claim 16, characterized in that:
at least a substantial part of a program is stored in the read-only-memory (ROM) and organised as modules, each one having an associated start address (P1-P3);
a pointer to each start address (P1-P3) is stored in the RAM;
and the mobile station Is adapted to:
in respect of at least one original module in the ROM, receive a corresponding replacement module (P2) and store it into the RAM;
replace the pointer to the original module in the ROM with a pointer to the replacement module in the RAM.

18. A mobile station (MS) according to any one of claims 15-17, characterized by means for receiving the program to be updated from a general-purpose computer.

19. A mobile station (MS) according to any one of claims 15-17, characterized by means for receiving the program to be updated via a radio path.

20. A mobile telephone network, characterized in that it comprises:
at least one software database (SDB) for updating programs in a mobile station (MS); and
at least one downloading unit (DLU) for loading programs into the mobile station (MS).
